(19) United States
(12) Patent Application Publication
(10) Pub. No.: US 2005/0149765 A1
(43) Pub. Date: Jul. 7, 2005

(54) Default address matching system

(76) Inventors: Harry W. Aldstadt, Woodbridge, VA (US); Michael C. Garner, Collierville, TN (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/451,321

(22) PCT Filed: Dec. 21, 2001
(86) PCT No.: PCT/US01/48782

(51) Int. Cl. G06F 1/26

(52) U.S. Cl. 713/300

(57) ABSTRACT

Systems and methods for determining default address information for mail items having incorrect or incomplete delivery addresses, where the default address information may be used to generate barcodes, which may be applied to the mail items to facilitate automated sorting of the mail items to carrier routes.

### CROSS REFERENCE TO RELATED APPLICATION

This application claims priority on U.S. Provisional Application Ser. No. 60/2565,976, filed Dec. 21, 2000, by Harry W. Aldstadt et al. and titled DEFAULT ADDRESS MATCHING SYSTEM, the entire content of which is expressly incorporated herein by reference.

### DESCRIPTION

1. Technical Field

This invention relates to automated sorting of mail items for delivery to recipients, and more specifically to a data processing system for determining default address information for a mail item having an incorrect or incomplete delivery address. The default address information may be used to generate a barcode, which facilitates automated sorting of the mail item to a carrier route for delivery of the mail item.

2. Background

The steady growth of traditional mail, coupled with steep increases in personnel costs, has resulted in increased operating costs for processing and delivering mail items. As is well known in the art, a mail item may include a delivery address having a recipient name, street information, and a geographic code, such as a ZIP Code to specify a geographical region for which to deliver the mail item. The street information may include a street address. The ZIP Code may be in any numeric format, and in the United States it is typically in a 5-digit format, a 9-digit format, or a ZIP-plus-four-plus-two (11-digit) format. The street information may include information identifying a specific delivery point on the street, for example, 212 W. Peach Tree St.

In conventional mail processing and delivery systems, such as the United States Postal Service (“USPS”), mail items having complete delivery addresses may be processed using automated sorting machines. In such mail processing systems, a mail item may go through several levels of sorting. Typically in the first sort a delivery address on a mail item is scanned and compared to information in a national directory, which contains information about valid addresses in a geographical zone, region, and/or country. More specifically, the national directory may include a database having records that represent valid addresses. The records may include information representative of the 9-digit format (or ZIP+4 format).

If a match is found, a barcode is generated that represents the delivery address, and the barcode is applied to the mail item. The barcode may include, for example, a delivery point barcode. A delivery point barcode may be representative of a single address. The information in the barcode may be used in the sorting process and/or to track the delivery status of the mail item. The barcode is readily scanned by high-speed automation equipment located in mail processing facilities. Then barcode sorters put the mail in sequence for delivery.

Otherwise, if a match is not found, personnel such as a clerk manually sorts the mail item to a carrier route. A clerk may be trained to memorize a sorting “scheme” for the delivery zone being sorted. The “scheme” training and manual sorting in this process may be labor intensive and costly.

Accordingly, there is a need for systems and methods for determining default address information for mail items having incorrect or incomplete delivery addresses. The default address information may be used to generate a barcode that may be applied to the mail item. Thereafter, the mail item may proceed in the automated sorting process until the mail item is sorted to a carrier route. Thus, such systems and methods may alleviate, at least in part, the disadvantage of manual sorting of mail items having an incomplete or incorrect delivery address.

This is achieved by providing for the determination of default address information based on a delivery address on the mail item, and thereafter using the default address information to generate a barcode that may be applied to the mail item.

### SUMMARY OF THE INVENTION

In accordance with one aspect of the present invention, systems and methods are disclosed for sorting mail items having an incorrect or incomplete delivery address. Such systems and methods receive a delivery address for a mail item; determine a default address information based on the received delivery address; responsive to determining the default address information, generate a barcode based on the default address information; apply the barcode to the mail item; and sorts the mail item.

In accordance with another aspect of the present invention, a method is disclosed for sorting mail items having an incorrect or incomplete delivery address. The method receives a mail item having an incorrect or incomplete delivery address; scans a delivery address on the mail item; determines a default address information based on the scanned delivery address; responsive to determining the default address information, generates a barcode based on the default address information; applies the barcode to the mail item; and sorts the mail item.

It is to be understood that both the foregoing general description and the following detailed description are exemplary and explanatory only and are not restrictive of the invention, as claimed.

The accompanying drawings, which are incorporated in and constitute a part of this specification, illustrate embodiments of the invention and together with the description, serve to explain the principles of the invention.

### BRIEF DESCRIPTION OF THE DRAWINGS

FIG. 1A is a flowchart showing a method for a conventional mail processing and distribution system.

FIG. 1B is a flowchart showing a method for a mail processing and distribution system consistent with the present invention.

FIG. 2 is a block diagram of a default address matching system consistent with the present invention.

FIG. 3 is a flowchart showing a method for a default address matching system consistent with the present invention.

FIG. 4 is a diagram showing a database for an Address Matching Database (“ADMS”) consistent with the present invention.

FIG. 5 is a diagram of results of processing by a default address matching system.

### DETAILED DESCRIPTION

Reference will now be made in detail to the exemplary embodiments of the invention, an example of which is illustrated in the accompanying drawings. Wherever possible, the same reference numbers will be used throughout the drawings to refer to the same or like parts.

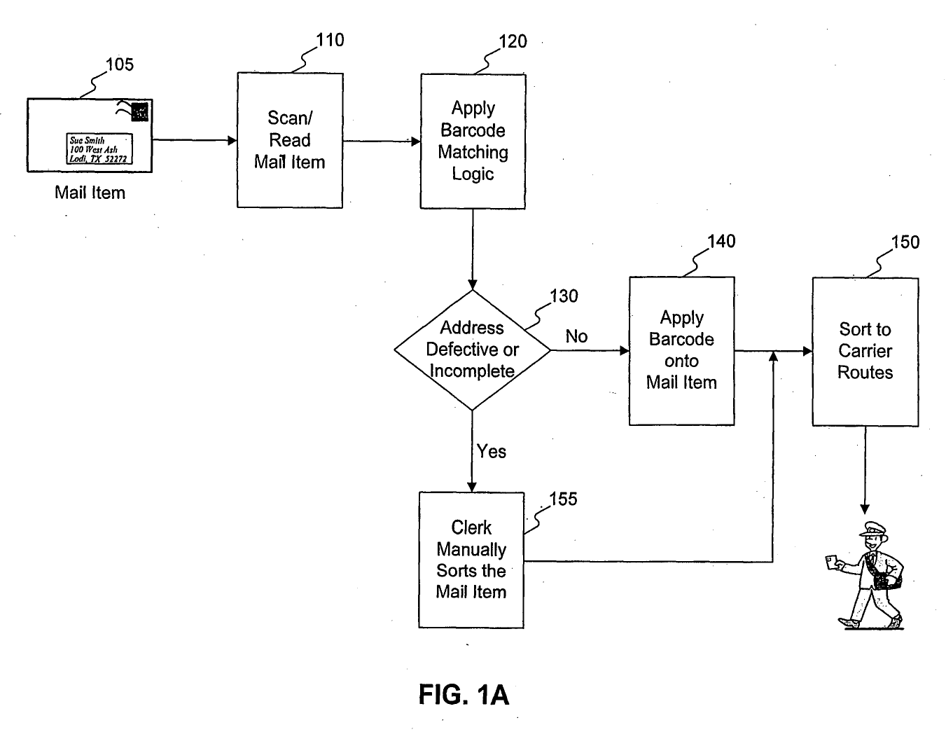

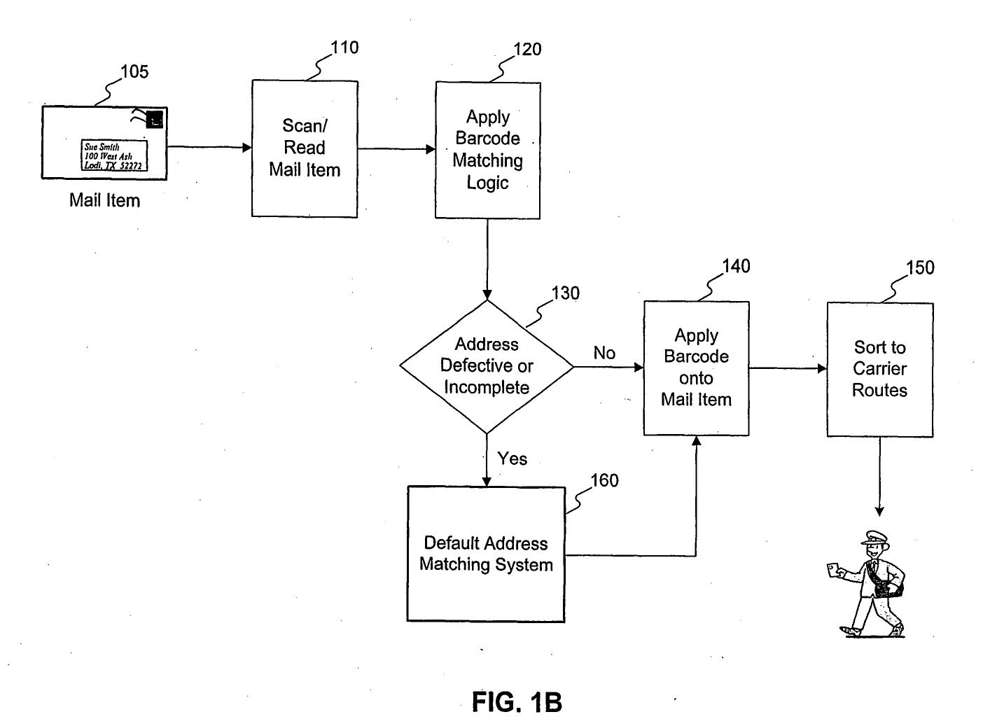

FIG. 1A is a flowchart showing a method for a conventional mail processing and distribution system. As shown in FIG. 1A, a mail item 105 may be received in a mail processing and distribution system. A scanner may read the delivery address on the mail item 105 (stage 110). The scanner may be coupled to a sorting machine. In one example, the scanner may scan the image of the delivery address on the mail item and may decode (or convert) the image to a character-based format that may be stored in a memory as the delivery address. The character-based format may include a format such as American Standard Code for Information Interchange (“ASCII”) or Extended Binary-Coded Decimal Interchange Code (“EBCDIC”). In another example, the delivery address on the mail item may be scanned by an optical character reader where the address elements may be determined by address recognition software.

Next, the scanned delivery address may be sent to a data processing system. The data processing system may apply bar code matching logic to query a national directory to determine whether the address is valid (stage 120). An address is deemed valid if a match exists in the national directory.

Based upon a determination that an address is valid, the data processing system generates a barcode based on the delivery address (stage 130). The barcode may be a delivery point barcode. As is known in the art, a delivery point barcode may represent an 11-digit ZIP Code having a ZIP-plus-four-plus-two format. Also, as known in the art, the first five digits of an 11-digit ZIP Code (or the ZIP in the ZIP-plus-four-plus-two format) represent a specific geographical region within the United States. More specifically, the first digit designates a broad geographical area of the United States, ranging from zero for the Northeast to nine for the far West. The second and third digits more closely pinpoint population concentrations and those sectional centers accessible to common transportation networks. The fourth and fifth digits designate small post offices or postal zones in larger zoned cities.

The next four digits in the 11-digit ZIP Code (or ZIP+4) will now be described. The sixth and seventh numbers denote a delivery sector, which may include, for example, several blocks, a group of streets, a group of post office boxes, several office buildings, a single high-rise office building, a large apartment building, or a small geographic area. The last two numbers denote a delivery segment, which may include, for example, one floor of an office building, one side of a street between intersecting streets, specific departments in a firm, or a group of post office boxes, etc. The last two digits in an 11-digit ZIP Code may include the last two digits of a street address.

After the barcode is generated for the mail item 105, it may be applied to the mail item 105 (stage 140). For example, the barcode may be sprayed (i.e., printed) onto the mail item 105 using, for example, fluorescent ink. Next, the mail item 105 continues in the sorting process until it is sorted to a carrier route (stage 150). At each sort level, the barcode may be scanned by a barcode sorter, and the mail item 105 routed to its next sort level or to a carrier route.

Based upon a determination that an address is not valid, the data processing system may send an indication that the mail item 105 is incomplete or incorrect (stage 130). Thereafter, a clerk manually sorts the mail item 105 (stage 155).

FIG. 1B is a flowchart showing a method for a mail processing and distribution system consistent with the present invention. As shown in FIG. 1B, a mail item 105 may be received in a mail processing and distribution system. A scanner may read the delivery address on the mail item 105 (stage 110). For example, the scanner may scan the image of the delivery address on the mail item and may decode (or convert) the image to a character-based format that may be stored in a memory as the delivery address. The character-based format may include a format such as American Standard Code for Information Interchange (“ASCII”) or Extended Binary-Coded Decimal Interchange Code (“EBCDIC”). The scanner may be coupled to a sorting machine. Next, the scanned delivery address may be sent to a data processing system. The data processing system may apply bar code matching logic to query a national directory to determine whether the address is valid (stage 120). An address is deemed valid if a match exists in the national directory.

Based upon a determination that an address is valid, the data processing system generates a barcode based on the delivery address (stage 130). The barcode may be a delivery point barcode. After the barcode is generated for the mail item 105, it may be applied to the mail item 105 (stage 140). For example, the barcode may be sprayed (i.e., printed) onto the mail item 105 using, for example, fluorescent ink. Next, the mail item 105 continues in the sorting process until it is sorted to a carrier route (stage 150). At each sort level, the barcode may be scanned by a barcode sorter, and the mail item 105 routed to its next sort level or to a carrier route.

Based upon a determination that an address is not valid, the data processing system may send an indication that the mail item 105 is incomplete or incorrect (stage 130). Thereafter, the delivery address may be sent to a default address matching system 160, wherein default address information may be determined and a barcode generated based on the default address information. The default address information may include street information, and optionally a geographic code.

After the barcode is generated for the mail item 105, it may be applied to the mail item 105 (stage 140). For example, the barcode may be sprayed (i.e., printed) onto the mail item 105 using, for example, fluorescent ink. Next, the mail item 105 continues in the sorting process until it is sorted to a carrier route (stage 150).

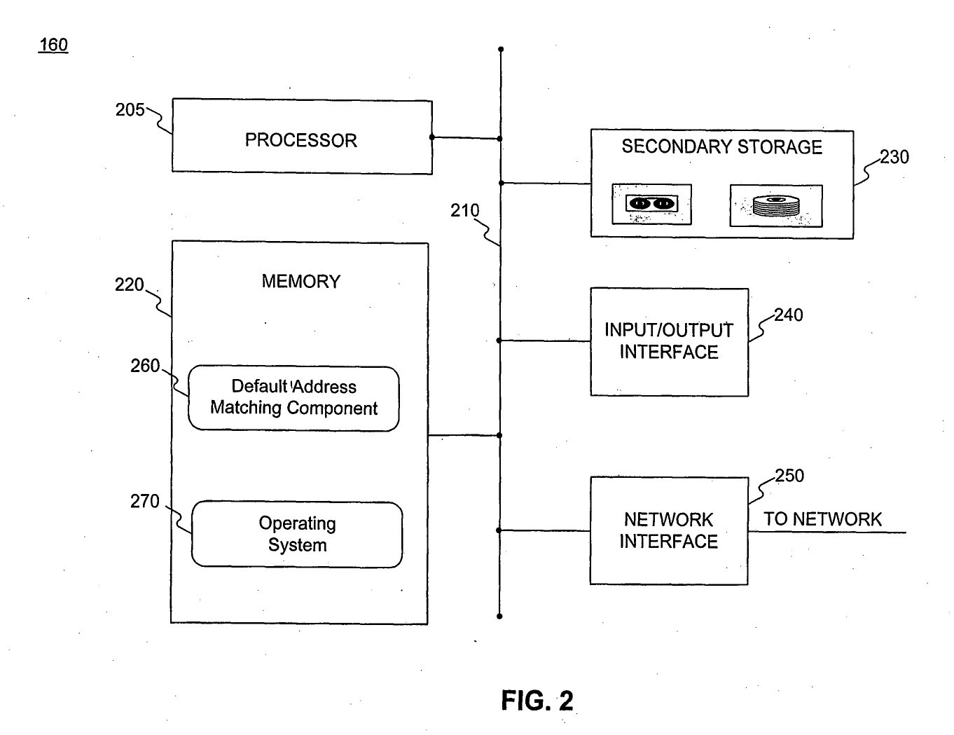

FIG. 2 is a block diagram of a Default address matching system 160 consistent with the present invention. Default address matching system 160 may be implemented using any appropriate type of computer, such as a personal computer, a workstation, a minicomputer, a mainframe computer, a hand-held device, etc. A default address matching system 160 may include a data processing system.

Default address matching system 160 may include a processor 205, a bus 210, a memory 220, a secondary storage 230, an input/output interface component 240, and a network interface component 250. Processor 205 may be any commercially available processor capable of executing program instructions, such as a Pentium microprocessor from Intel Corporation, a SPARC processor, a Power PC microprocessor, or a PA_RISC processor. Bus 210 facilitates communication of data and other information among components of Default address matching system 160.

Memory 220 may include a default address matching component 260 for determining a default address information for an incomplete or incorrect delivery address on a mail item, generating a barcode based on the default address information, and applying the barcode to the mail item. Default address matching component 260 may also be stored on secondary storage 230 and loaded into memory 220 to provide instructions for determining a default address information for an incomplete or incorrect delivery address on a mail item, generating a barcode based on the default address information, and applying the barcode to the mail item. Default address matching component 260 may be implemented in any appropriate computer programming language, scripting tool, or other software tool, examples of such being C++, C, Java, Hypertext Markup Language (“HTML”), or Visual Basic.

In addition, memory 220 may include an operating system 270 for generally controlling and coordinating operation of data processing system 133. Operating system 270 controls allocation of system resources. It performs tasks, such as memory management, process scheduling, networking, and services, among other things. Memory 220 may be configured using random access memory (“RAM”) alone or in combination with other types of memory.

Secondary storage 230 may be configured using any computer-readable medium, such as a hard disk drive, a compact disc (“CD”) drive, and/or a read/write CD drive. From secondary storage 230, software and data may be loaded into memory 220. Similarly, software and data in memory 220 may be stored on secondary storage 230. In addition, secondary storage 230 may include an Address Matching System Database (“ADMS”), which will be described below in detail. Alternatively, an ADMS database may reside on a server system and may be accessed via a network.

Input/Output interface component 240 may include one or more of a keyboard, a pointing device, a voice recognition device, a keypad, display unit, or a printing device. Network interface module 250 may include hardware and software for sending and receiving data over a network, and may be used, for example, to send or receive information with a sorting machine or a data processing system or another computer.

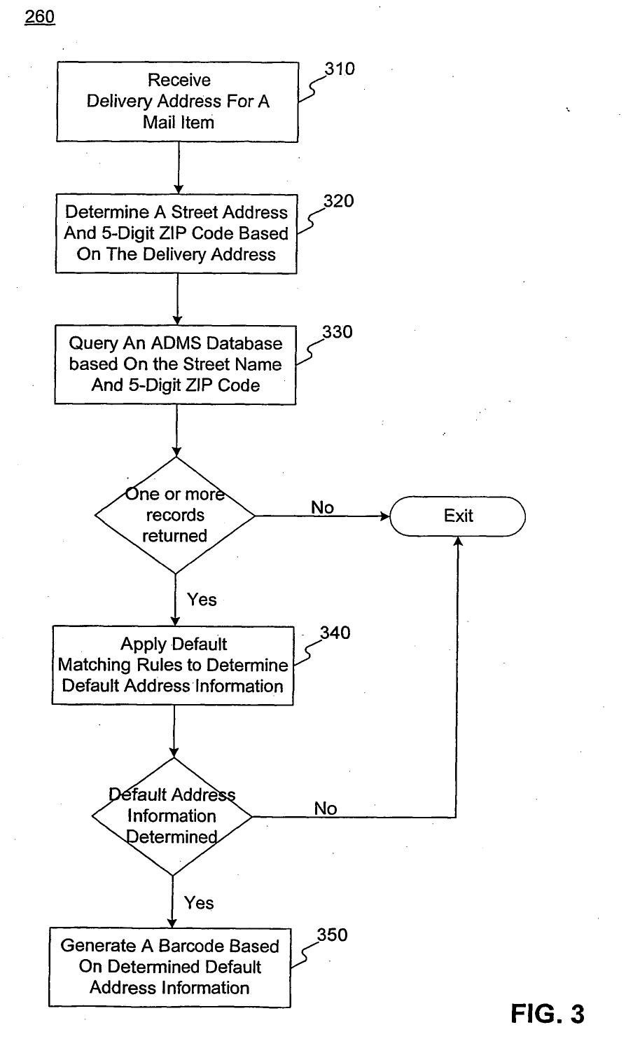

FIG. 3 is a flowchart showing a method for a default address matching system consistent with the present invention. As shown in FIG. 3, default address component 260 may receive a delivery address for a mail item (stage 310). For example, the address may have been sent from a data processing system to default address component 260.

Thereafter, default address component 260 may determine a street address based on the delivery address. In addition, default address component 260 may determine a geographic code, such as a 5-digit ZIP Code if one exists in the delivery address (stage 320). The street address and geographic code may be determined by applying commonly known parsing methods to the delivery address. Default address component 260 may determine a default address information based on the street address and geographic code, and may generate a default ZIP+4 barcode for a mail item 105 having a valid street name but having incomplete or incorrect data elements for matching to an address in a national directory. For example, a mail item 105 may have a street address as 1 West Ash Ave., but the correct address is 1 Ash Ave.

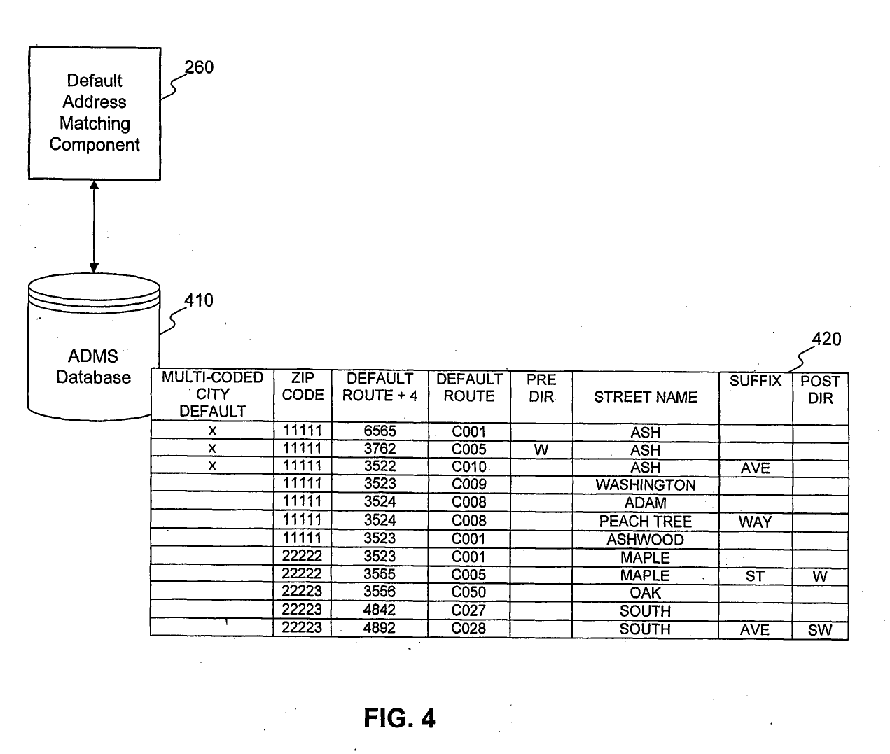

To determine a default address information, Default address component 260 may query a national address directory, such as an ADMS database for one or more records that match the street address, and if determined, a geographic code (stage 330). Alternatively, the national address directory may include a file stored on a directory file system on secondary storage 230. In one example, each carrier route is assigned a ZIP+4 default route that is designated to receive mail that cannot be delivery point barcoded due to having an incomplete or incorrect delivery address. Street names may be assigned to the default routes. An ADMS database may include information for mapping a street name in a delivery address to one or more default routes. An example of an ADMS database is shown in FIG. 4 As shown in FIG. 4, The ADMS database 410 may include a default route table 420 having fields that may include values for a 5-digit ZIP Code, default route+4, default route, pre directional, street name, suffix, and post directional elements. The pre directional field may include information designating a pre-directional value, such as W for West. The default route+4 may include information designating a four-digit numeric value. The post directional field may include information designating a post-directional value, such as SW for South West. The default route field may include information designating a default carrier route.

Returning back to FIG. 3, if no records are returned from the query (“No”), then default address information may not be determined and default address component 260 may exit and return an appropriate status. Otherwise (“Yes”), then default address component 260 may apply one or more default matching rules to the information in the returned records to determine a default address information for the mail item 105 (stage 340). For example, the default matching rules may include at least one of the following: (1) a record with two or more matched elements have a higher weight over a record with less matched elements; (2) a higher match weight is given to street name and directional(s) than to street name and suffix; (3) pre directional has a higher match weight than post directional; (4) the match may be made to street name in the default route table 420; and (5) do not match if the input address has one matched component and the default route table 420 has two or more address elements for a match record.

For example, if a delivery address for a mail item 105 has a street address “1 ASH”, and the default route table 420 returns two records, one with a street name “ASH” and the other with “W. ASH”, default address component 260 may determine a default route+4 code based on the record for “ASH”. In another example, if a delivery address for a mail item 105 has a street address “1 WEST ASH AVE”, the default route table 420 may return three records, a first record with a street name “W ASH”, a second with a street name “ASH”, and the third with “W. ASH”. Default address component 260 may determine a default route+4 code based on the record for “W ASH”.

In yet another example, if a delivery address for a mail item 105 has a street address “3201 WASHINGTON AVE”, and the default route table 420 returns a record with a street name “WASHINGTON”, default address component 260 may determine a default route+4 code based on the record for “WASHINGTON”. In a final example, if a delivery address for a mail item 105 has a street address “3301 PEACH TREE”, and the default route table 420 returns a record with a street name “PEACH TREE”, default address component 260 may not determine a default route+4 code for the delivery address because the record has a suffix of “WAY” that is not included in the street address.

A default route+4 code may include a 5-digit ZIP Code and a default route+4 value. For example, a default route+4 code for a street address “1 ASH” may be 11111-6565. The default route corresponds to carrier route C001. The default address information may include the default route+4 code.

Once a default route+4 code is determined, default address component 260 may generate a barcode based on the default address information (stage 350). The barcode may include, for example, a delivery point barcode in an 11-digit ZIP Code format. After the barcode is generated for the mail item 105, it may be applied to the mail item. For example, the barcode may be sprayed (i.e., printed) onto the mail item 105 using, for example, fluorescent ink. Next, the mail item 105 continues in the sorting process until it is sorted to carrier route C001 for delivery.

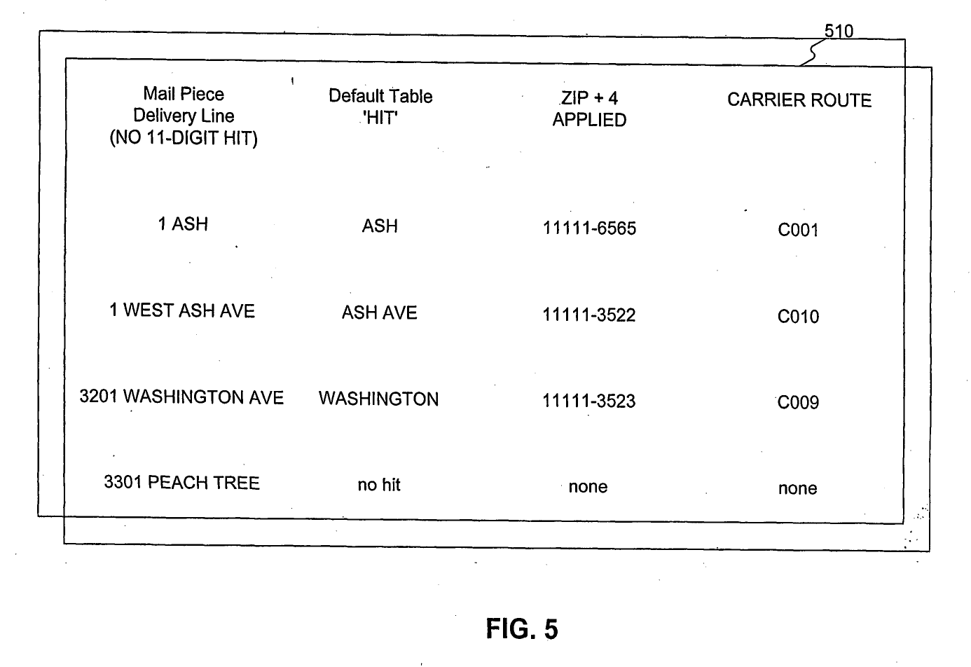

FIG. 5 is a diagram of results 510 of processing by a default address matching system. The diagram correlates with the examples described above in FIG. 4, and shows the default route+4 code (ZIP+4 applied field) that may be generated for each example and the default route (carrier route field).

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method for sorting mail items having an incorrect or incomplete delivery address, the method comprising:
receiving a delivery address for a mail item;
determining a default address information based on the received delivery address;
responsive to determining the default address information, generating a barcode based on the default address information;
applying the barcode to the mail item; and
sorting the mail item.

2. The method of claim 1, wherein determining a default address information comprises:
determining a street address and a geographic code by parsing the delivery address;
querying a national address directory for records that match the street address and the geographic code; and
responsive to one or more records being returned from the query, applying one or more default address matching rules to the returned records to determine the default address information.

3. The method of claim 2 wherein the geographic code includes a 5-digit ZIP Code.

4. The method of claim 2, wherein the returned records include one or more of the following: geographic code, default route+4 information, carrier route information, pre directional information, post directional information, street name, and suffix.

5. The method of claim 1, wherein the default address information includes a geographic code.

6. The method of claim 5 wherein the geographic code includes a 9-digit ZIP Code or an 11-digit ZIP Code.

7. A system for sorting mail items having an incorrect or incomplete delivery address, the system comprising:
means for receiving a delivery address for a mail item;
means for determining a default address information based on the received delivery address;
means for generating a barcode based on the default address information;
means for applying the barcode to the mail item; and
means for sorting the mail item.

8. The system of claim 7, wherein the means for determining a default address information comprises:
means for determining a street address and a geographic code by parsing the delivery address;
means for querying a national address directory for a record that matches the street address and the geographic code; and
means for applying one or more default address matching rules to the record to determine the default address information.

9. A system for determining default address information for mail items having an incorrect or incomplete delivery address and using the default address information to generate barcodes for the mail items, the system comprising:
a processor; and
a memory unit in communication with the processor and storing a program component, wherein the processor is operative with the program component to
receive a delivery address for a mail item;
determine a default address information based on the received delivery address; and
generate a barcode based on the default address information.

10. A computer readable medium containing instructions for controlling a computer system to perform a method for determining default address information for mail items having an incorrect or incomplete delivery address and using the default address information to generate barcodes for the mail items, the method comprising:
receiving a delivery address for a mail item;
determining a default address information based on the received delivery address; and
responsive to determining the default address information, generating a barcode based on the default address information.

11. The computer readable medium of claim 10, wherein determining a default address information comprises:
determining a street address and a geographic code by parsing the delivery address;
for querying a national address directory for a record that matches the street address and the geographic code; and
applying one or more default address matching rules to the record to determine the default address information.

12. A computer program product comprising:
a computer usable medium having computer readable instructions embodied therein for determining default address information for mail items having an incorrect or incomplete delivery address and using the default address information to generate barcodes for the mail items, the computer usable medium comprising:
means for receiving a delivery address for a mail item;
means for determining a default address information based on the received delivery address; and
means for generating a barcode based on the default address information.

13. The computer program product of claim 12, wherein the means for determining a default address information comprises:
means for determining a street address and a geographic code by parsing the delivery address;
means for querying a national address directory for a record that matches the street address and the geographic code; and
means for applying one or more default address matching rules to the record to determine the default address information.

14. A method for sorting mail items having an incorrect or incomplete delivery address, the method comprising:
receiving a mail item having an incorrect or incomplete delivery address;
scanning a delivery address on the mail item;
determining a default address information based on the scanned delivery address;
responsive to determining the default address information, generating a barcode based on the default address information;
applying the barcode to the mail item; and
sorting the mail item.

15. The method of claim 14, wherein determining a default address information comprises:
determining a street address and a geographic code by parsing the delivery address;
querying a national address directory for records that match the street address and the geographic code; and
responsive to one or more records being returned from the query, applying one or more default address matching rules to the returned records to determine the default address information.

16. The method of claim 15 wherein the geographic code includes a 5-digit ZIP Code.

17. The method of claim 15, wherein the returned records include one or more of the following: geographic code, default route+4 information, carrier route information, pre directional information, post directional information, street name, and suffix.

18. The method of claim 14, wherein the default address information includes a geographic code.

19. The method of claim 18 wherein the geographic code includes a 9-digit ZIP Code or an 11-digit ZIP Code.
